(19) United States
(12) Patent Application Publication
(10) Pub. No.: US 2014/0236529 A1
(43) Pub. Date: Aug. 21, 2014

(54) Method and Apparatus for Determining Displacement from Acceleration Data

(71) Applicant: MOTOROLA MOBILITY LLC, Libertyville, IL (US)

(72) Inventor: Julius S. Gyorfi, Vernon Hills, IL (US)

(73) Assignee: MOTOROLA MOBILITY LLC, Libertyville, IL (US)

(21) Appl. No.: 13/769,549

(22) Filed: Feb. 18, 2013

(51) Int. Cl. G06F 17/10; G01B 21/16

(52) U.S. Cl. CPC G06F 17/10; G01B 21/16
USPC 702/141; 702/150

(57) ABSTRACT

A method (100) and apparatus (900) for determining displacement from acceleration data is disclosed. The method (100) comprises partitioning (106), for an axis of acceleration, filtered acceleration data into a sequence of segments with at least one positive acceleration time segment and at least one negative acceleration time segment. The method (100) further comprises force fitting (118), by a processor (910), each positive acceleration time segment and an adjacent negative acceleration time segment into a model positive and negative acceleration pair curve such that a cumulative velocity value of the model positive and negative acceleration pair curves is equal to zero. Finally, the method (100) double integrates (120) the model positive and negative acceleration pair curves to obtain the displacement corresponding to the acceleration data.

### FIELD OF THE DISCLOSURE

The present disclosure relates generally to acceleration measurements and more particularly to determining displacement from acceleration data.

### BACKGROUND

A point-to-point motion of a human hand theoretically produces a symmetric, normalized acceleration profile constrained to begin and end with zero velocity and acceleration. The raw data measured from consumer grade accelerometers during such point-to-point motion exhibits none of the above characteristics due to thermal noise, mechanical noise, bias, instability, inaccurate gravity compensation, quantization errors, varying sampling rates, and other inherent inaccuracies in the devices themselves. Neither deterministic nor stochastic filtering is sufficient to clean up the data to the degree required to determine displacement because of the above identified problems.

Accordingly, there is an opportunity to establish a method and apparatus for determining accurate displacement from raw acceleration data.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a flowchart for a method for determining displacement in accordance with some embodiments.

FIG. 2 illustrates received acceleration data for an example gesture plotted as acceleration time waveforms on the X, Y, and Z axes, respectively, in accordance with some embodiments.

FIG. 3 illustrates acceleration time waveforms before and after filtering the acceleration data of FIG. 2 in accordance with some embodiments.

FIG. 4 illustrates acceleration time waveforms before and after partitioning the filtered acceleration data of FIG. 3 in accordance with some embodiments.

FIG. 5 illustrates acceleration time waveforms before and after expanding the partitioned acceleration data in accordance with some embodiments.

FIG. 6 illustrates modified acceleration time waveforms on the X and Y axes, respectively, for the example gesture of FIG. 2 in accordance with some embodiments.

FIG. 7 illustrates the displacement (shape) resulting from the modified acceleration time waveforms of FIG. 6 represented on the XY plane for the example gesture of FIG. 2 in accordance with some embodiments.

FIG. 8 illustrates the original and modified acceleration time waveforms plotted on the X, Y, and Z axes and their displacement results for the example gesture of FIG. 2.

FIG. 9 shows a schematic block diagram of an apparatus in accordance with some embodiments.

FIG. 10 illustrates raw and modified acceleration plots on the X, Y, and Z axes, respectively, for tracing a triangle in a three dimensional space.

FIG. 11 illustrates displacements resulting from the raw and modified acceleration data of FIG. 10 in accordance with some embodiments.

FIG. 12 illustrates raw and modified acceleration plots on the X, Y, and Z axes, respectively, for tracing a square in a three dimensional space.

FIG. 13 illustrates displacements resulting from the raw and modified acceleration data of FIG. 12 in accordance with some embodiments.

FIGS. 14-39 represent reconstructed displacement (shapes) for acceleration data created when tracing letters A-Z of the alphabet as obtained in accordance with some embodiments.

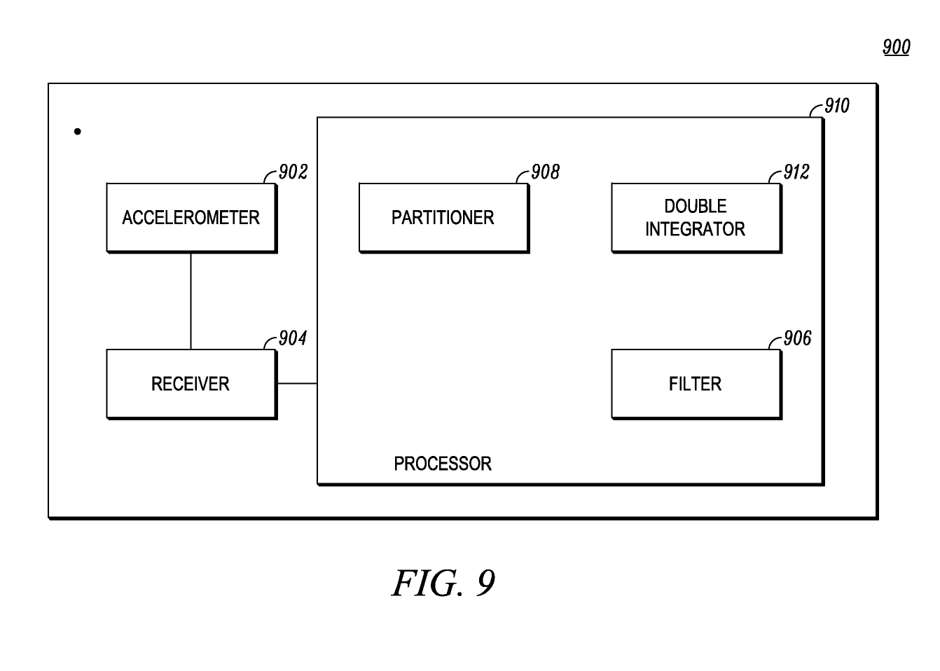

Skilled artisans will appreciate that schematic elements in FIG. 9 are illustrated for simplicity and clarity and have not necessarily been drawn to scale. The apparatus and method components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

### DETAILED DESCRIPTION

Disclosed is a method and apparatus for determining displacement from raw acceleration data. The method includes filtering the raw acceleration data and partitioning, for an axis of acceleration, filtered acceleration data into a sequence of segments with at least one positive acceleration time segment and at least one negative acceleration time segment. The method further includes force fitting, by a processor, each positive acceleration time segment and an adjacent negative acceleration time segment into a model positive and negative acceleration pair curve such that a cumulative velocity value of the model positive and negative acceleration pair curve is equal to zero. Furthermore, the method includes double-integrating the model positive and negative acceleration pair curves to obtain the displacement corresponding to the acceleration data.

The disclosed method and apparatus modifies raw acceleration measurements based on an understanding of human motion symmetries and constraints. The method can be used in gesture recognition and user input applications. A user will be able to move a device through space representing different shapes and symbols that correspond to specific actions and the method and apparatus reconstructs the displacement from collected acceleration data which is modified according to the teachings of this disclosure. The reconstructed displacement may be used by a device as a gesture control or data input.

For example, a user input movement in space may follow letters of the alphabet or numerals. If the user motions to draw letters or numerals in space, the shape or the displacement obtained using the disclosed embodiments is close to the original shape of the letter or numeral generated by the user. The present disclosure may be used to determine displacement in three dimensional space from accelerometer measurements.

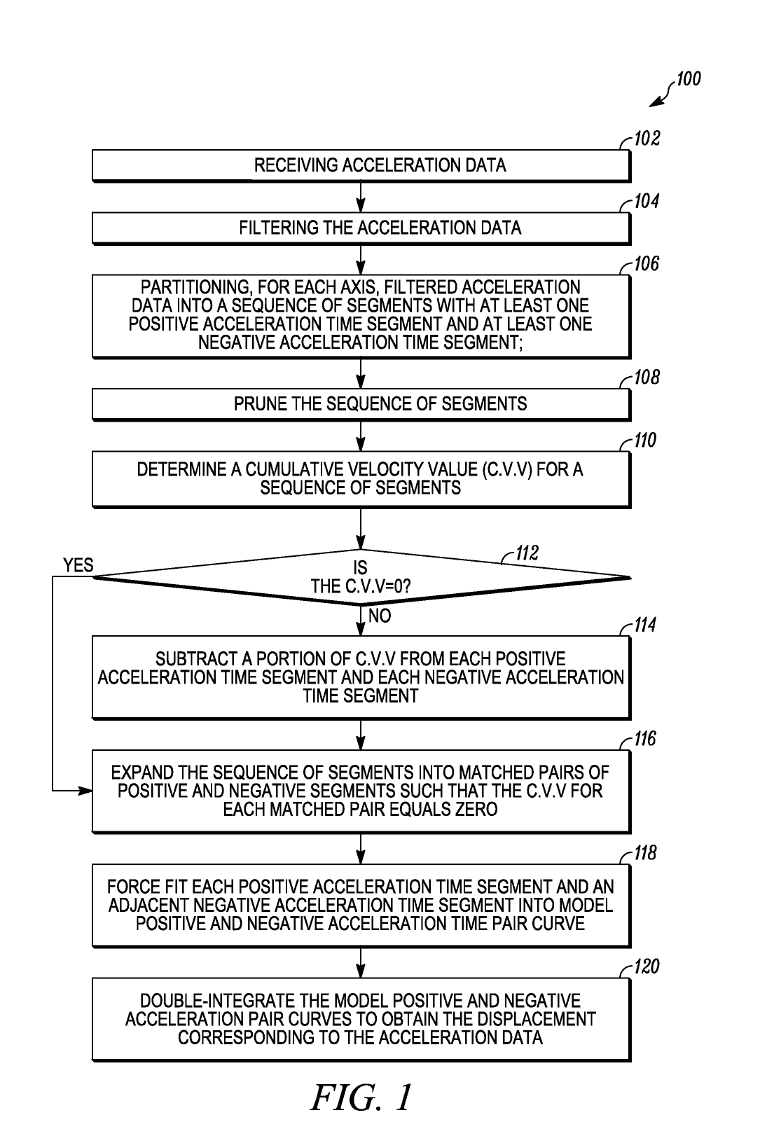

FIG. 1 illustrates an exemplary method of determining displacement from acceleration data. A simple point-to-point motion along a single axis requires an acceleration to initiate the motion and a corresponding deceleration to stop the motion. The area under an acceleration curve is the resultant velocity produced by the acceleration. In an ideal scenario, for a point-to-point motion, the areas underneath the acceleration and deceleration curves exactly cancel.

Further, a compound point-to-point movement is equivalent to multiple simple point-to-point movements or basic motion units (BMUs). The compound movements can be made up of discrete movements or be one continuous movement. Each of the simple and compound movements in three dimensions can be resolved into single-axis motions along each principal axis namely, the X axis, the Y axis, and the Z axis.

The method 100 receives 102 the acceleration data as a user performs a gesture. In one embodiment, the received acceleration data is a raw acceleration data. For example, the raw acceleration data may be a simple point-to-point motion, human hand point-to-point motion, or a compound point-to-point motion in a two-dimensional space or a three-dimensional space.

The acceleration time waveforms for a simple point-to-point motion or a compound point-to-point movement can be characterized by a sequence of positive and negative area segments. Also, the basic units of human hand motion can be plotted on acceleration time curves which can be used to reproduce displacement in accordance with the embodiments described. The continuous motion in three dimensional space will produce compound movements which can be expanded into basic motion units to generate accurate displacements.

In order to explain the steps of the flowchart 100 in detail, the flowchart 100 is explained with an example of obtaining displacement for a hand moving in a gesture similar to a letter ‘B’ traced in space. In order to capture acceleration data, an accelerometer may be held in the hand while tracing the ‘B’ shape or may be attached to a finger or wrist. The accelerometer may be part of another device such as a mobile electronic computer, a mobile phone, a tablet computing device, a digital personal assistant, a GPS receiver, a gaming controller, a remote control, or another type of electronic device. Although, the flowchart is explained using the example of tracing a ‘B’, one skilled in the art should understand that the example is merely for illustrative purposes and the invention should not be limited to the embodiments described here. The displacement can be calculated for the various other letters, numerals, shapes, patterns, etc.

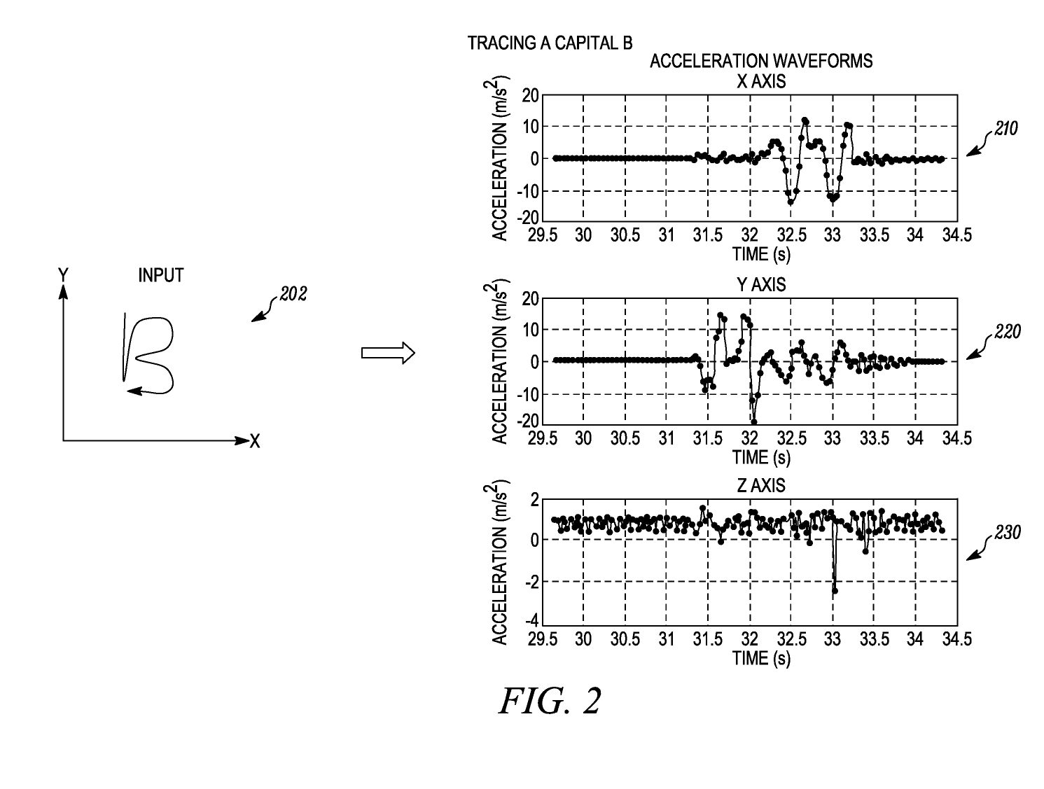

FIG. 2 depicts raw acceleration data illustrated on the X, Y, and Z axes for the letter ‘B’ 202 as traced by a human hand holding an accelerometer within a mobile phone. The acceleration time waveforms 210, 220, and 230 represent the acceleration time curves for the letter ‘B’ in the X axis, Y axis, and Z axis, respectively. In other words, the plots 210, 220, and 230 represent the acceleration versus time waveforms in the X, Y, and Z axes for the received acceleration data of this instance of tracing the letter ‘B’ 202.

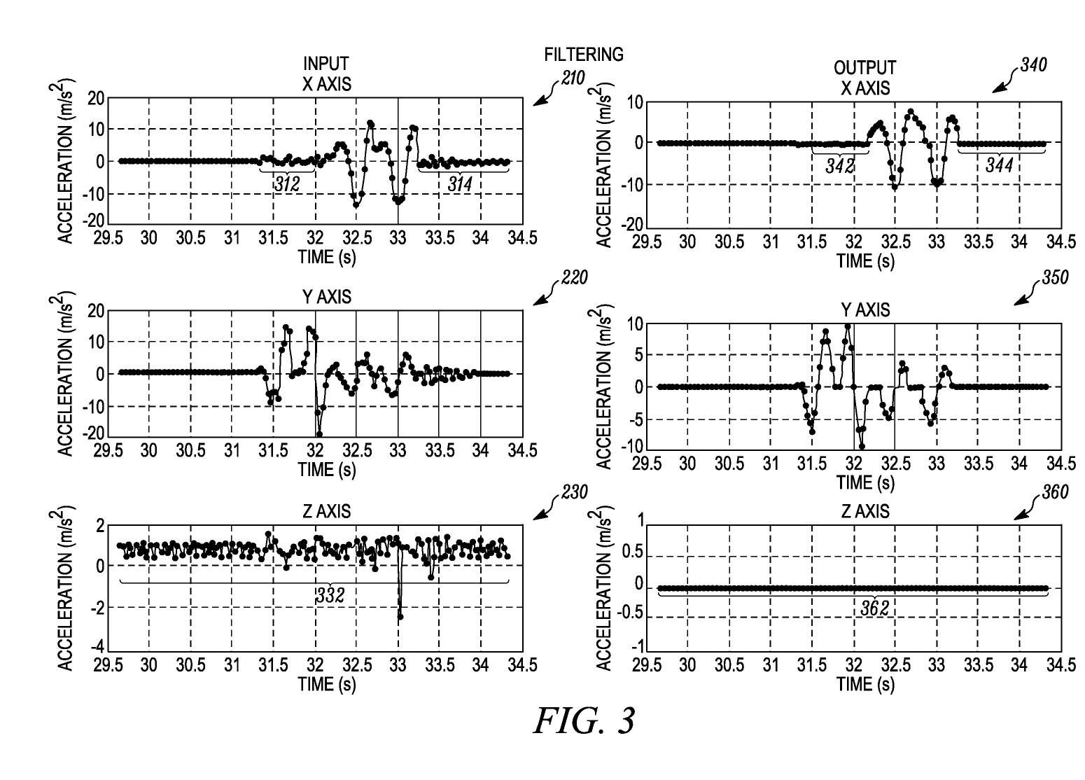

Returning to FIG. 1, the method 100 then filters 104 the received acceleration data to produce filtered acceleration data as explained in detail with reference to FIG. 3. FIG. 3 shows two sets of the waveforms, namely, input waveforms, 210, 220, 230, and output waveforms, 340, 350, 360. The input waveforms are the acceleration time curves 210, 220, 230 from FIG. 2.

As shown in FIG. 3, the process of filtering 104, filters the input acceleration time curve 210 to produce the output acceleration time curve 340. In one example, the acceleration time curve 340 is produced by filtering an unwanted noise portion 312 on the acceleration time curve 210 to produce the smooth portion 342 on the acceleration time curve 340. Similarly, the noisy portion 314 from the acceleration time curve 210 is filtered to produce the smooth portion 344 on the curve 340. In other words, the filtering 104 removes a noise portion from the acceleration time waveform 210 to produce the filtered acceleration time waveform 340 at the output side. Further, the process of filtering 104 also filters the acceleration time curves 220 and 230 to produce the acceleration time curves 350 and 360, respectively. Filtering 104 may reduce noise and bias. For example, the acceleration time curve 230 includes a consistent bias 332 in the Z axis. The output acceleration time curve 360 eliminates the bias and noise to produce the portion 362 having zero acceleration in the Z axis.

In accordance with the embodiments, the filtering includes smoothing. The smoothing can include computing an X-point moving average of the received acceleration data, where X is greater than one. In another embodiment, the filtering includes noise suppression. The noise suppression further includes zeroing out any acceleration data with an amplitude absolute value below a predetermined threshold value. The predetermined threshold value can be set by a manufacturer of a filter or the user. In still another embodiment, the filtering includes bias elimination. Bias elimination can be done by determining an average value of the acceleration data and subtracting the average value from each datum of the acceleration data.

Therefore, the process of filtering 104 may employ various methods of filtering to filter the raw acceleration data in order to generate the filtered acceleration data represented by the acceleration time curves 340, 350, 360, for example, for the letter ‘B’.

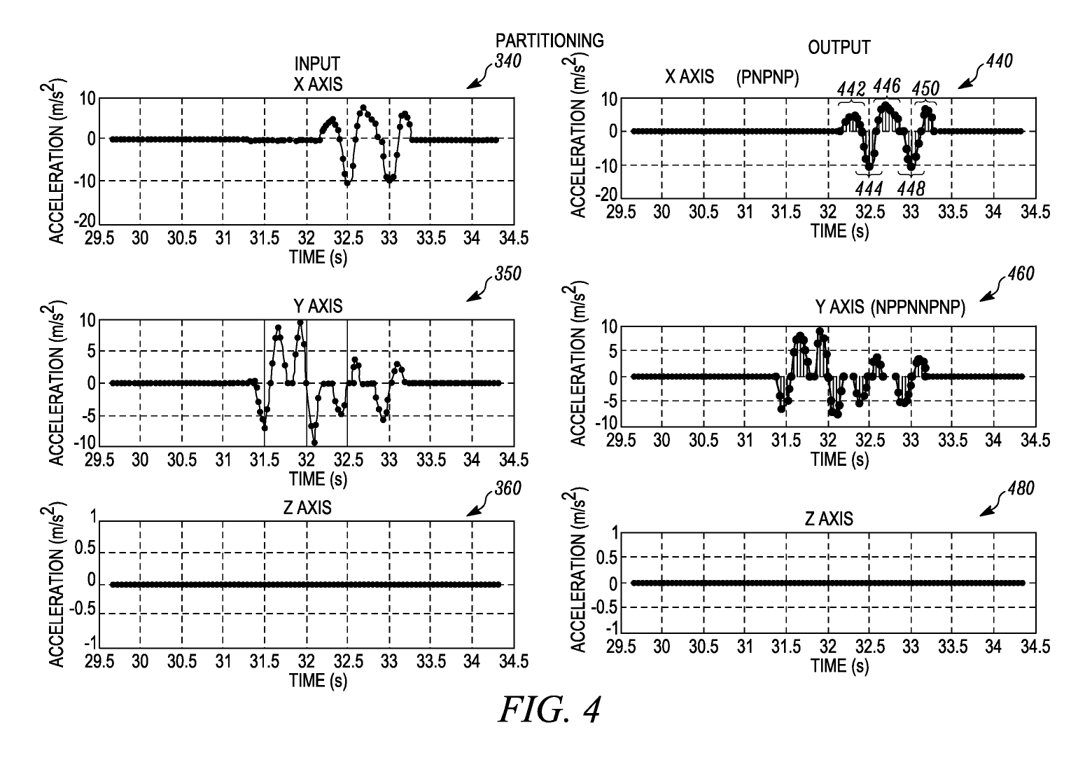

Referring back to FIG. 1, after filtering 104, the method 100 partitions 106, for each axis of acceleration, the filtered acceleration data into a sequence of positive and negative acceleration time segments. In other words, partitioning 106 involves identifying positive and/or negative acceleration time segments, which will be explained in detail with reference to FIG. 4.

Referring to FIG. 4, the left hand side represents the input waveforms 340, 350, 360 for the process of partitioning 106. These input waveforms are from the output side of the filtering process 104 of FIG. 3.

The partitioning 106 identifies a sequence of positive and negative acceleration time segments in the filtered acceleration data. In other words, the partitioning 106 partitions each of the filtered acceleration time waveform into a sequence of positive and negative acceleration time segments. For example, the partitioning 106 partitions the acceleration time curve 340 on the X axis at the input side to produce the output waveform 440. The output waveform, i.e., the acceleration time waveform 440, produced after the partitioning process 106 includes the identified positive and the negative acceleration time segments. In the present example, at the X-axis, on the acceleration time curve 440, the portion 442 represents the first ‘positive segment’, the portion 444 represents the next ‘negative segment’, the portion 446 represents the next ‘positive segment’, the portion 448 represents the next ‘negative segment’, and the portion 450 represents the next ‘positive segment’. Therefore, the step of partitioning 106 involves identifying the sequence of positive and negative acceleration time segments, for example, PNPNP in the acceleration time waveform 440 for the example letter ‘B’.

Similarly, the partitioning 106 identifies the positive and the negative segments for the acceleration time curve 350 on the Y axis to produce the acceleration time curve 460. In the acceleration time waveform 460 on the Y axis, the positive and negative acceleration time segments are identified, for example, NPPNNPNP. Further, because the Z axis now represents zero acceleration, the output acceleration time curve 480 on the Z axis is same as the input acceleration time curve 360. In other words, because, the Z axis represents a zero acceleration curve, the process of partitioning 106 does not identify positive and negative acceleration time segments for the Z axis in the current example. However, one skilled in art should understand that in case the acceleration time curve on the Z axis represents non-zero acceleration, the partitioning 106 similarly identifies the positive and negative segments for the Z axis.

Referring back to FIG. 1, after partitioning 106, the method 100 prunes 108 the sequence of segments. Pruning 108 removes positive and negative acceleration time segments that do not satisfy time, speed, and average acceleration thresholds. Pruning 108 provides an additional degree of filtering. The threshold values used in the filtering 104 and the partitioning process 106 may result in some degenerate segments. For example, within a pure noise portion, one or two data points may survive noise suppression creating an invalid acceleration time segment. Therefore, the pruning 108 removes unnecessary acceleration time segments.

In the present example of tracing the letter ‘B’, no segments are needed to be pruned because the process of filtering 104 and partitioning 106 did not result in any invalid positive and negative acceleration time segments. However, one skilled in art should understand that in case the filtering and the partitioning process create invalid positive and negative acceleration time segments, the process of pruning 108 prunes the acceleration time waveforms 440, 460, 480 to remove the unwanted positive and negative acceleration time segments.

After pruning 108, the method 100 determines 110 a cumulative velocity value (C.V.V) for the remaining sequence of positive and negative acceleration time segments. In other words, the method 100 then calculates a cumulative velocity value for each of the acceleration time curves 440, 460, 480 on the X axis, Y axis, and the Z axis after the pruning 108. In one embodiment, the cumulative velocity value is calculated by summing an integration of each positive and negative acceleration time segment.

The method 100 further moves to determining 112 if each cumulative velocity value equals to zero. If the cumulative velocity value is not equal to zero, the method 100 subtracts 114 a portion of the cumulative velocity value from each positive acceleration time segment and each negative acceleration time segment. In one embodiment, the method 100 subtracts an equal fraction of the cumulative velocity value from each positive acceleration time segment and each negative acceleration time segment. The above steps results in an updated cumulative velocity value, for each of the X axis, Y axis, and the Z axis, equal to zero. Thereafter, the cumulative velocity value for each of the acceleration time curves on the X axis, Y axis, and the Z axis will be zero. Consequently, the net resultant area under each of the acceleration time curves on each axis equals zero.

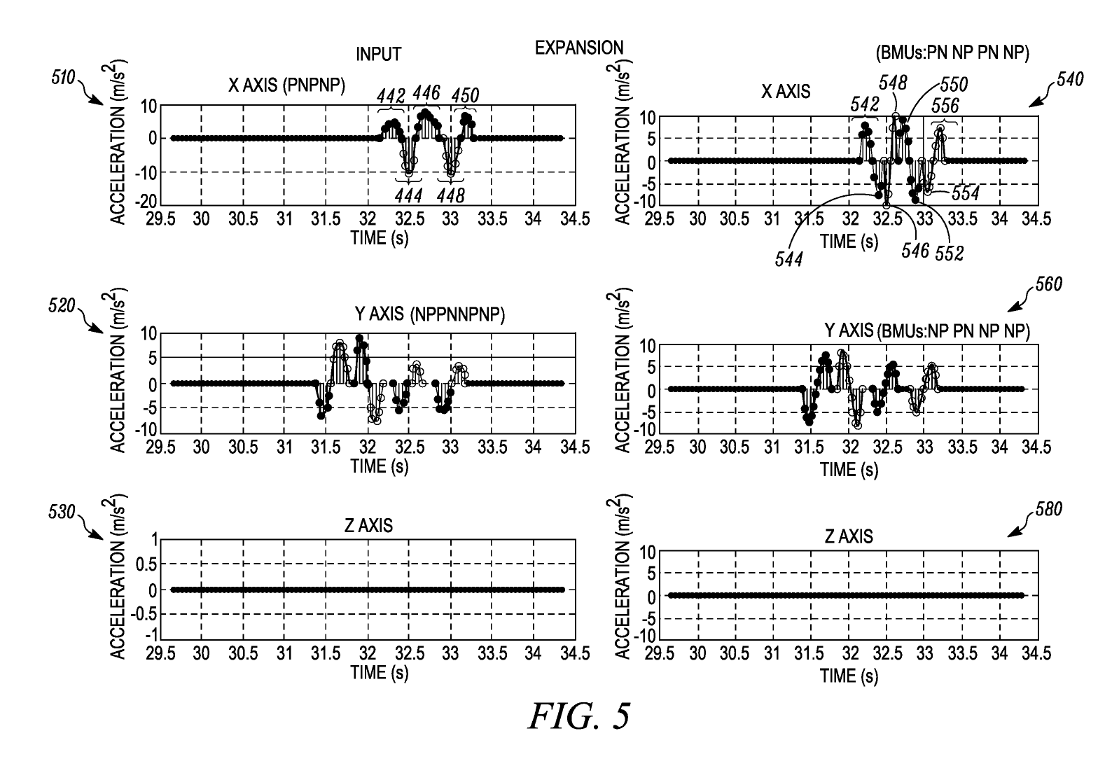

The method 100 then moves to expanding 116 the sequence of segments into matched pairs of positive and negative segments such that the cumulative velocity value for each matched pair equals to zero. In other words, each of the positive and negative acceleration time segments produced after step 114 is expanded 116 to produce a matched pair of positive and negative acceleration time segments such that the areas under each positive and the corresponding matched negative acceleration time segment are the same and the net resultant combined area is zero. The process of expansion is explained in detail with reference to FIG. 5.

FIG. 5 illustrates acceleration time waveforms before and after expansion 116 in accordance with some embodiments. The left hand side of FIG. 5 represents input waveforms 510, 520, 530 plotted on the X axis, Y axis, and the Z axis, respectively. These input waveforms are the acceleration time curves or waveforms produced after performing step 106, 108, or 114 of FIG. 1. In the present example, because the pruning 108 was not required and the acceleration time waveforms on the X axis and the Y axis have minor cumulative velocity values (approximately equal to zero), the acceleration time waveforms 510, 520, 530 are same as the acceleration time waveforms 440, 460, 480 produced after the partitioning process 106. However, if the pruning 108 is performed and the cumulative velocity value is not equal to zero, then the acceleration time waveforms 510, 520, 530 are the ones received after the step 114 of the method 100. Further, if the cumulative velocity value is equal to zero, the method 100 directly produces the acceleration time waveforms 510, 520, 530 after pruning 108 and skipping the step 114 of FIG. 1. The process of expansion 116 expands a sequence of segments into matched pairs of positive and negative segments such that the cumulative velocity value for each matched pair equals zero.

For example, the acceleration time curve 510, which is same as the acceleration time curve 440 of FIG. 1 in the present example, on the X axis represents a sequence of segments 442 (positive segment), 444 (negative segment), 446 (positive segment), 448 (negative segment), and 450 (positive segment). Expansion expands the acceleration time curve 510 on the X axis to produce the acceleration time curve 540 at the output side. The process of expansion modifies the positive segment 442 on the acceleration time curve 440 at the input side to produce the positive segment 542 on the acceleration time curve 540 at the output side. Further, the process also modifies the next negative segment 444 on the acceleration time curve 510 into two negative segments 544, 546 on the acceleration time curve 540, such that the area of the first negative segment 544 is exactly same as the area of the leftmost positive segment 542.

Consequently, the matched pair of segments 542, 544 is formed at the acceleration time curve waveform 540 such that the cumulative velocity value for the matched pair equals zero and the sum of the net resultant area of the matched pair of segments also equals zero. Further, the positive segment 446 at the acceleration time curve 510 is modified into two positive segments 548, 550 at the acceleration time curve 540, such that the area of the positive segment 548 is same as the area of the preceding negative segment 546 resulting in the next matched pair of segments having zero cumulative velocity value and zero net resultant total area.

Furthermore, the negative segment 448 at the acceleration time curve 510 is modified into two negative segments 552, 554 at the acceleration time curve 540 such that the area of the first negative part 552 is same as the area of the preceding positive segment 550 resulting in zero cumulative velocity value of the matched pair. Therefore, the next matched pair of positive segment 550 and negative segment 552 is formed such that the cumulative velocity value of the matched pair equals zero and the sum total of the area under the matched pair of segments equals zero. The negative segment 554 at the acceleration time curve 540 has the area same as the last segment 556 at acceleration time curve 510. This is true because the cumulative velocity must be zero due to FIG. 1 steps 112, 114. Thus, the process of expansion 116 expands the sequence of positive and negative segments into matched pairs of positive and negative segments such that the cumulative velocity value for each matched pair equals zero. In the present example, the expansion 116 expands the sequence of segments on the acceleration time curve 440 to produce the matched pairs 542 and 544 (PN), 546 and 548 (NP), 550 and 552 (PN), 554 and 556 (NP).

The process of expansion is similarly followed for the acceleration time curve 520 on the Y axis to produce the acceleration time curve 560. For the Z axis, in this example, because there is no acceleration, the acceleration time curve 580 is same as the acceleration time curve 530.

Therefore, the process of expansion 116 modifies each of the acceleration time curves on the X axis, Y axis, and Z axis into basic motion units to form matched pairs of positive and negative acceleration time segments such that the cumulative velocity value for each matched pair equals to zero.

Referring back to FIG. 1, the method 100 then moves to force fitting 118 each positive acceleration time segment and an adjacent negative acceleration time segment into a model positive and negative acceleration pair curve. The process of force fitting 118 ensures that the positive and negative acceleration time curves have symmetric shapes and temporal features, such as cross-over points. In one embodiment, a maximum positive amplitude of the model positive and negative acceleration pair curve is equivalent to a maximum negative amplitude of the model positive and negative acceleration pair curve. In one embodiment, a time span of a positive amplitude portion of the model positive and negative acceleration pair curve is equal to a time span of a negative amplitude portion of the model positive and negative acceleration pair curve.

In one embodiment, the method 100 constructs the model positive and negative acceleration pair curve in accordance with a “minimum jerk” model. The ‘minimum jerk’ model refers to the physiological fact that natural human movements tend to minimize jerk, which is the time-derivative of acceleration. Thus, a deliberate movement that has a large-amplitude, small-time-period, for example, “model positive-and-negative acceleration pair curve”, would consequently exhibit significant jerk.

The method 100 uses a mathematical model to fit a particular curve shape to each segment given by the minimum jerk model. The curve, normalized in amplitude and time is given by the equation a(t)=120*t̂3−180*t̂2+60*t where t is between 0 and 1. This curve can be scaled in time to fit any time range and it can be scaled in amplitude to match any area. The shape of this curve is the “ideal” theoretical acceleration curve that is force-fitted over the real-life, irregularly-shaped curves. The force-fitting matches the time ranges and areas.

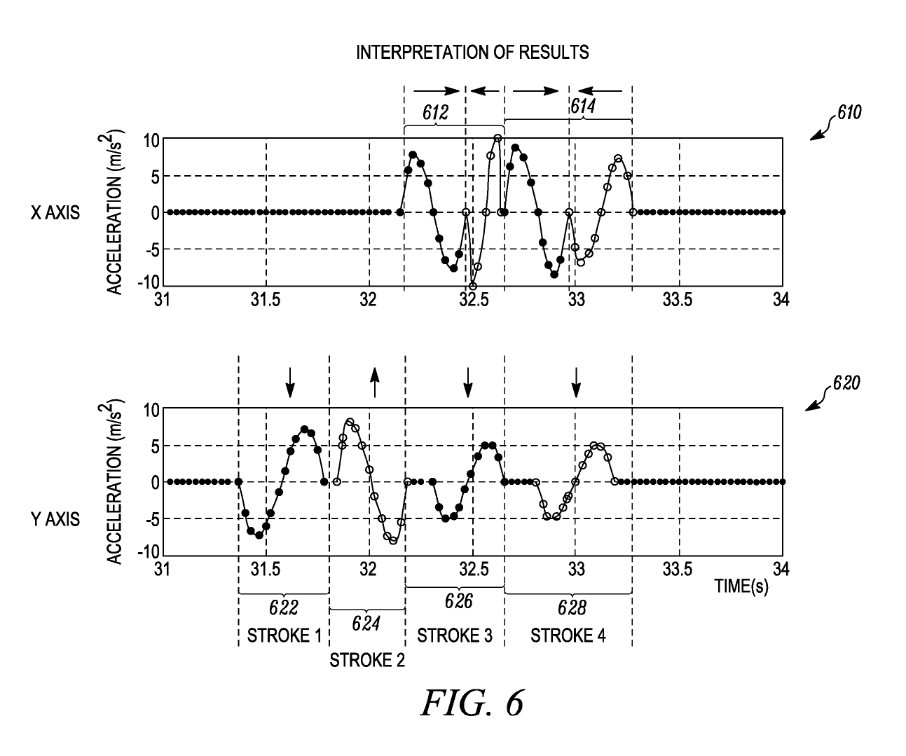

In the present example, FIG. 6 represents the model positive and negative acceleration time curves after filtering 104, partitioning 106, and expanding 116 acceleration data 210, 220, 230 received from tracing the letter ‘B’ 202 shown in FIG. 2. The acceleration time curve 610 represents the model acceleration time curve on the X axis and the acceleration time curve 620 represents the model acceleration time curve on the Y axis. Close examination of the curves of FIG. 6 provides a hint as to the displacement of the acceleration sensor in an XY plane.

FIG. 6 depicts stroke 1 including the curve 622 on the Y axis and the stroke is only down. Stroke 2 includes the curve 624 on the Y axis and it is only up. Stroke 3 includes the curve 612 on the X axis and the curve 626 on the Y axis and provides the displacement to the right and down side and then returning to the left side while continuing down thereby forming an arc. Similarly, stroke 4 includes the curve 614 on the X axis and the curve 628 on the Y axis and provides the displacement to the right and down side and returning left while still moving down thus forming another arc.

Thus, the acceleration time waveforms 610 and 620 depict the model acceleration curves and the strokes provide the hint for the corresponding displacement of the model acceleration waveforms relevant to the letter ‘B’ of the FIG. 2.

Referring back to FIG. 1, if it is determined 112 that the cumulative velocity equals zero, the method 100 directly moves to the steps of expanding 116 and then force fitting 118. After force fitting 118 each positive acceleration time segment and an adjacent negative acceleration time segment into a model positive and negative acceleration time pair curve, the method 100 double integrates 120 the model positive and negative acceleration pair curves to obtain the displacement corresponding to the initial acceleration data from FIG. 2.

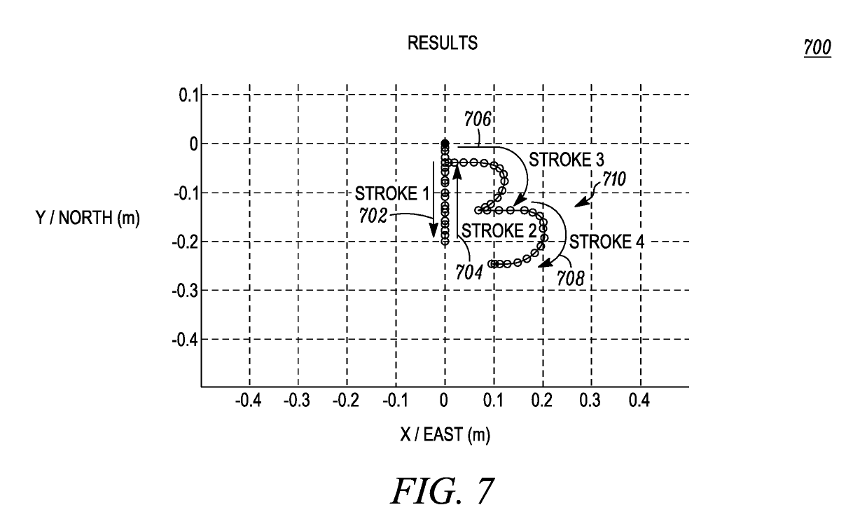

In the present example, the model positive and negative acceleration pair curves for the letter ‘B’ are double integrated to produce the reconstructed displacement depicted in FIG. 7. Referring to FIG. 7, the XY plot 700 represents the displacement 710 (or the resultant shape) produced from the received raw acceleration data of FIG. 2. In the graph 700, 702 represents the first stroke of the letter ‘B’ resulting from the curve 622 of FIG. 6, 704 represents the second stroke of letter ‘B’ resulting from the curve 624 of FIG. 6, 706 represents the third stroke of letter ‘B’, resulting from the curves 612 and 626 of FIGS. 6, and 708 represents the fourth stroke of the letter ‘B’ resulting from the curves 614 and 628 of FIG. 6.

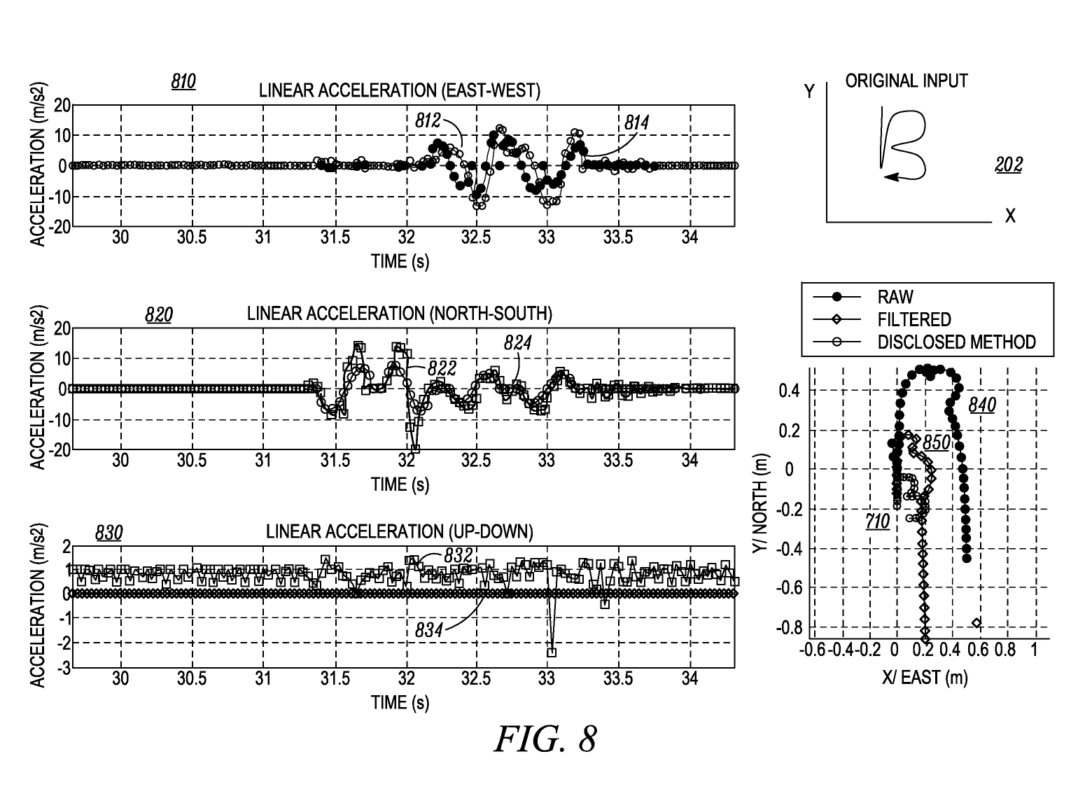

FIG. 8 represents a comparison of the results produced in accordance with the embodiments described against the results produced with conventional methods. The plot 810 includes a dotted acceleration time curve 812 representing the received raw acceleration data, for example, the acceleration time waveform 220 of FIG. 2, and includes a solid acceleration time curve 814 representing the model acceleration time curve, for example, the acceleration time waveform 610 in FIG. 6.

Similarly, on the Y axis, the plot 820 represents the acceleration time curves 822 and 824. The dotted acceleration time curve 822 represents the received raw acceleration data, for example, waveform 220 as represented in FIG. 2. The solid acceleration time curve represents a model acceleration time curve, for example, the acceleration time waveform 620 of FIG. 6, produced after the step of force fitting in accordance with the described embodiments.

Further, on the Z axis, the plot 830 represents the acceleration time curves 832 and 834. The acceleration time curve 832 is the received raw acceleration data, for example, as represented by the waveform 230 on FIG. 2. The acceleration time curve 832 is in accordance with the described embodiments.

In addition, the right hand side of FIG. 8 represents the original input trace 202, for example, the letter ‘B’. The plot or shape 840 represents the results of double integration of the received raw acceleration data 812, 822, 832. Meanwhile, the plot 710 represents the double integration of the model acceleration time curves produced in accordance with the described embodiments. Further, the plot 850 represents the results of double integration of the filtered acceleration data 340, 350, 360 of FIG. 2. One skilled in art can see that the displacement 710 obtained using the embodiments results in an output much closer to the original input than the displacement 840 obtained by integrating raw acceleration data or the displacement 850 obtained by integrating the filtered acceleration data. Further, the flow chart of FIG. 1 may be implemented as part of a portable electronic device or as an electronic device coupled to an accelerometer sensor.

FIG. 9 illustrates a block diagram of an example apparatus for implementing various embodiments. Specifically, device 900 can be employed to determine displacement from the raw acceleration data. Device 900 comprises an accelerometer 902, a receiver 904, and a processor 910 implementing a filter 906, a partitioner 908, and a double integrator 912. The device may be implemented as a mobile phone, a personal digital assistant, a gaming controller, a remote controller, a wired or wireless mouse, an electronic stylus or pen, or another type of electronic device. The device 900 may be a multi-part device with one element attachable to a hand, wrist, finger, or writing utensil having the accelerometer 902 and a short range transmitter and another element that contains a compatible receiver 904 plus the processor 910 and other elements shown in FIG. 9.

The accelerometer 902 provides the raw acceleration data. The accelerometer 902 may be any accelerometer such as an analog interface accelerometer, pulsewidth interface accelerometer, or 12C interface accelerometer. The accelerometer 902 alone is sufficient only if the orientation of the device 900 remains constant during its motion, for example, if the device 900 is not rotating while it is translating. If the device 900 changes the orientation during motion, the X, Y, and Z axes also change and the acceleration data will be measured with respect to a changing coordinate reference frame. In such a scenario, an integrated accelerometer, gyroscope, compass in conjunction with a fusion algorithm may be used to provide acceleration with respect to a fixed reference frame.

Further, data from the accelerometer may suffer from thermal noise, mechanical noise, bias, instability, inaccurate gravity compensation, quantization errors, varying sampling rates, and other inaccuracies. The receiver 904 enables the apparatus 900 to receive the raw acceleration data, including its inaccuracies, from the accelerometer 902. If applicable, the receiver 904 converts the acceleration data received from the accelerometer 902 to digital data for use by the processor 910.

The device 900 further includes a filter 906 configured to filter 104 the acceleration data received 102 by the receiver 904. In one embodiment, the filter 906 is configured to compute an X-point moving average of the received acceleration data, where X is greater than 1. Further, in another embodiment, the filter 906 zeroes out any acceleration data with an amplitude absolute value below a predetermined threshold value. In still another embodiment, the filter 906 may determine an average value of the acceleration data and subtract the average value from each datum of the acceleration data. See FIG. 3 for further examples of filter usage.

The device 900 further includes a partitioner 908 configured to partition 106, for an axis of acceleration, filtered acceleration data into a sequence of segments with at least one positive acceleration time segment and at least one negative acceleration time segment. See FIG. 4 for examples of partitioner usage. The processor 910, after the partitioning process 106, prunes 108 the sequence of segments and determines 110 a cumulative velocity value for the sequence of segments. Further, the processor 910 determines 112 if the cumulative velocity value equals zero. If the cumulative velocity value is not equal to zero, the processor 910 subtracts 114 a portion of cumulative velocity value from each positive acceleration time segment and each negative acceleration time segment. Furthermore, the processor 910 expands 116 the sequence of segments into matched pairs of positive and negative segments such that the cumulative velocity value for each matched pair equals zero.

When the processor 910 determines that the cumulative velocity value equals zero, the processor 910 performs the expansion process 116. Subsequently, the processor 910 force fits 118 each positive acceleration time segment and an adjacent negative acceleration time segment, after the expansion process, into a model positive and negative acceleration pair curve such that a cumulative velocity value of the model positive and negative acceleration pair curves is equal to zero. The processor 910 may be implemented as a microcontroller, a digital signal processor, hard-wired logic and analog circuitry, or any suitable combination of these.

Finally, the double integrator 912 double integrates 120 the model positive and negative acceleration pair curves to produce the reconstructed displacement corresponding to the received acceleration data.

It is to be understood that FIG. 9 is for illustrative purposes only and is not intended to be a complete schematic diagram of the various components and connections there between required for the apparatus 900. Therefore, the apparatus 900 will include various other components not shown in FIG. 9, and/or have various other configurations internal and external, and still be within the scope of the present disclosure. For example, the device 900 may also include a display, a light emitting diode, keys, or other user interface components. Also, one or more of these components may be combined or integrated in a common component, or component features may be distributed among multiple components. Also, the components of the apparatus 900 may be connected differently, without departing from the scope of the invention.

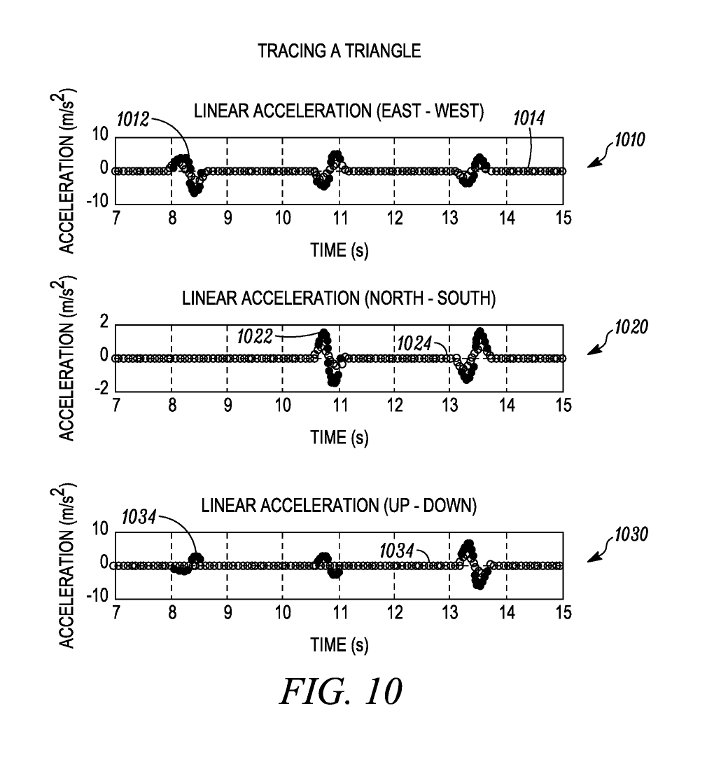

FIG. 10 illustrates raw and modified acceleration plots 1010, 1020, and 1030 on the X, Y, and Z axes, respectively, for tracing a triangle in a three dimensional space. The plot 1010 on the X axis shows an acceleration time waveform 1012 that represents the received raw acceleration data created when tracing the example triangle and the acceleration time waveform 1014 that resulted from implementing the method 100. In other words, the acceleration time waveform 1014 includes model acceleration time curves as described in the flowchart 100. Similarly, the plot 1020 on the Y axis includes an acceleration time waveform 1022 that represents the received raw acceleration data that resulted from tracing the example triangle, and the acceleration time waveform 1024 is produced in accordance with method 100. Also, the plot 1030 on the Z axis shows an acceleration time waveform 1032 for the received raw acceleration data and the acceleration time waveform 1034 produced by the method 100.

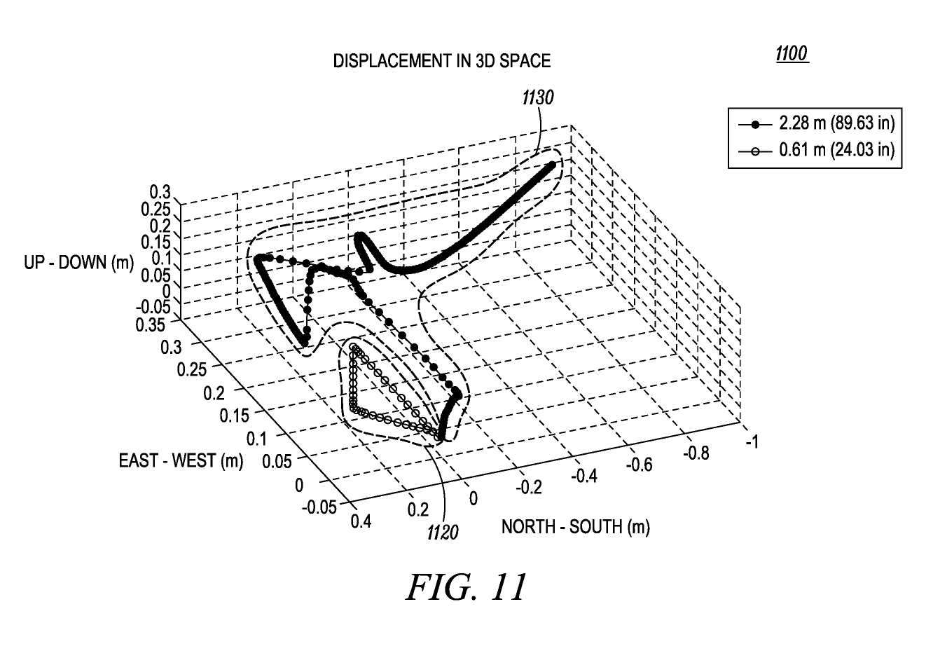

FIG. 11 illustrates the reconstructed displacements 1100 resulting from the initial acceleration data for tracing an example triangle and also from the modified acceleration data in accordance with the embodiments described. The modified acceleration time curves 1014, 1024, and 1034 of FIG. 10 are double integrated to produce the triangle 1120. Also, when the acceleration time curves 1012, 1022, and 1032 are double integrated, the shape 1130 is produced. Therefore, if the received raw acceleration data is directly double integrated, the displacement produced suffers greatly from any data errors and the resultant shape obtained deviates from the original intended shape.

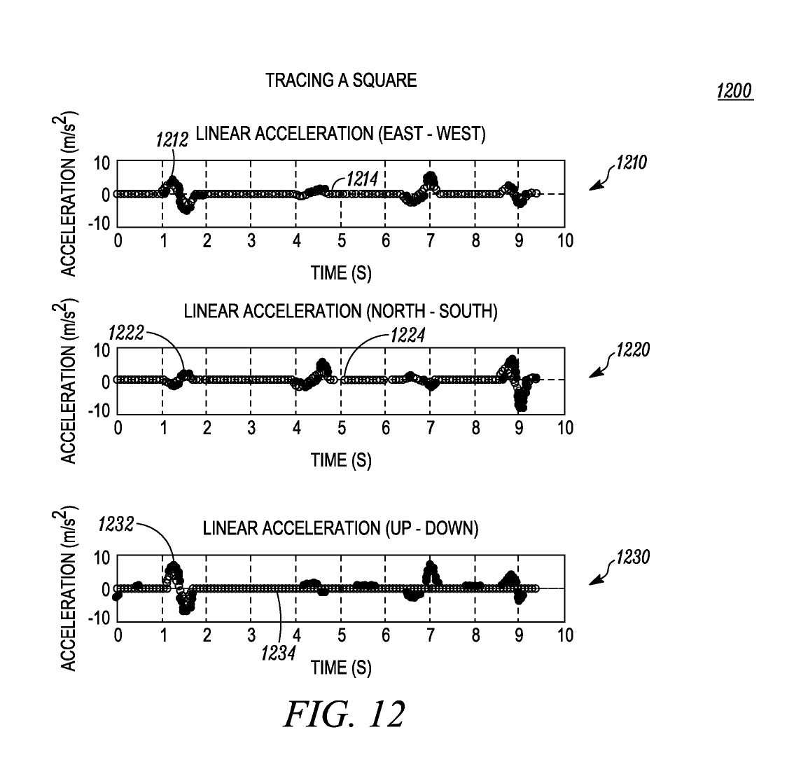

FIG. 12 illustrates raw and modified acceleration plots 1210, 1220, and 1230 plotted on the X, Y, and Z axis, respectively, for tracing a square in a three dimensional space. The plot 1210 on the X axis shows and acceleration time waveform 1212 that represents the received raw acceleration data created when tracing the example square and the acceleration time waveform 1214 that resulted from implementing the method 100. In other words, the acceleration time waveform 1214 includes model acceleration time curves as described in the flowchart 100. Similarly, the plot 1220 on the Y axis includes an acceleration time waveform 1222 that represents the received raw acceleration data that resulted from tracing the example square, and the acceleration time waveform 1224 is produced in accordance with the method 100. Also, the plot 1230 on the Z axis shows an acceleration time waveform 1232 for the received raw acceleration data and the acceleration time waveform 1234 produced by method 100.

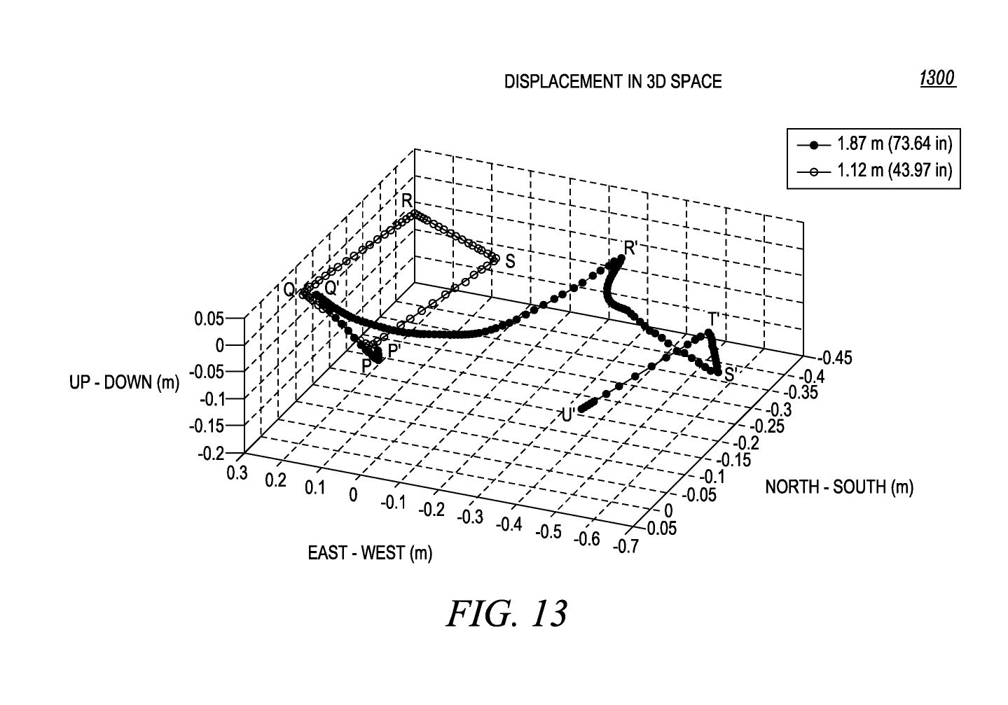

FIG. 13 illustrates the reconstructed displacements 1300 resulting from the initial acceleration data for tracing an example square and from the modified acceleration data in accordance with the embodiments described. The modified acceleration time curves 1214, 1224, and 1234 of FIG. 12 are double integrated to produce the square PQRS. Also, when the acceleration time curves 1212, 1222, and 1232 are double integrated, the shape produced is represented by the points P′Q′R′S′T′U′. Therefore, if the received raw acceleration data is directly double integrated, the displacement produced suffers greatly from any data errors and the resultant shape obtained deviates from the original intended shape.

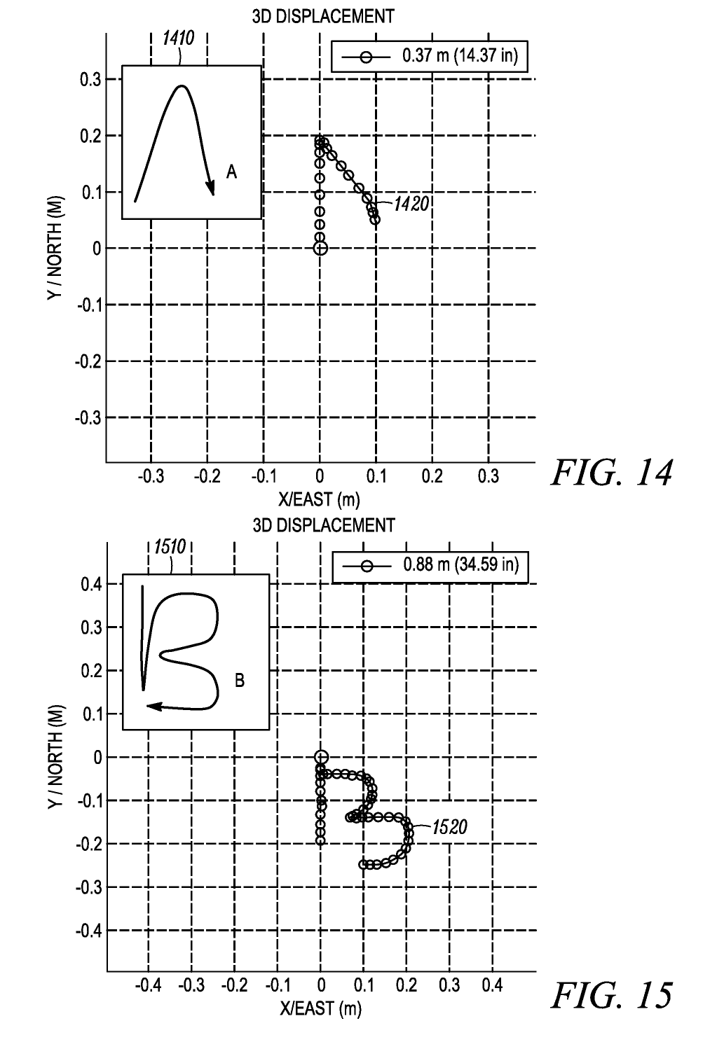

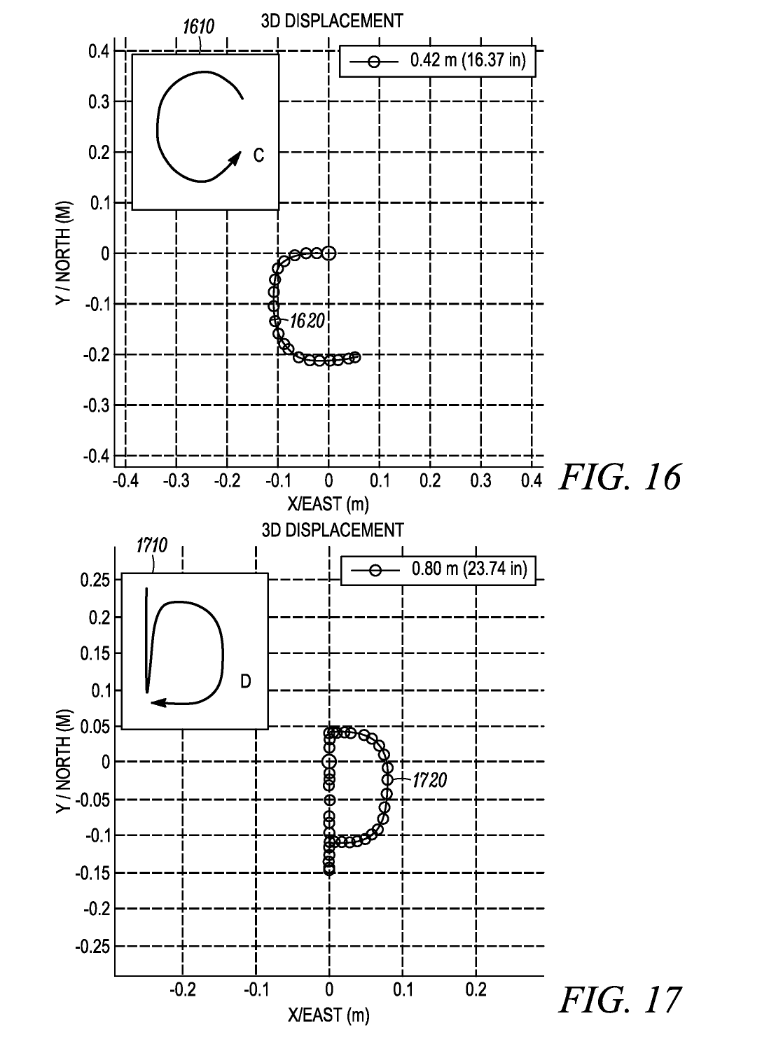

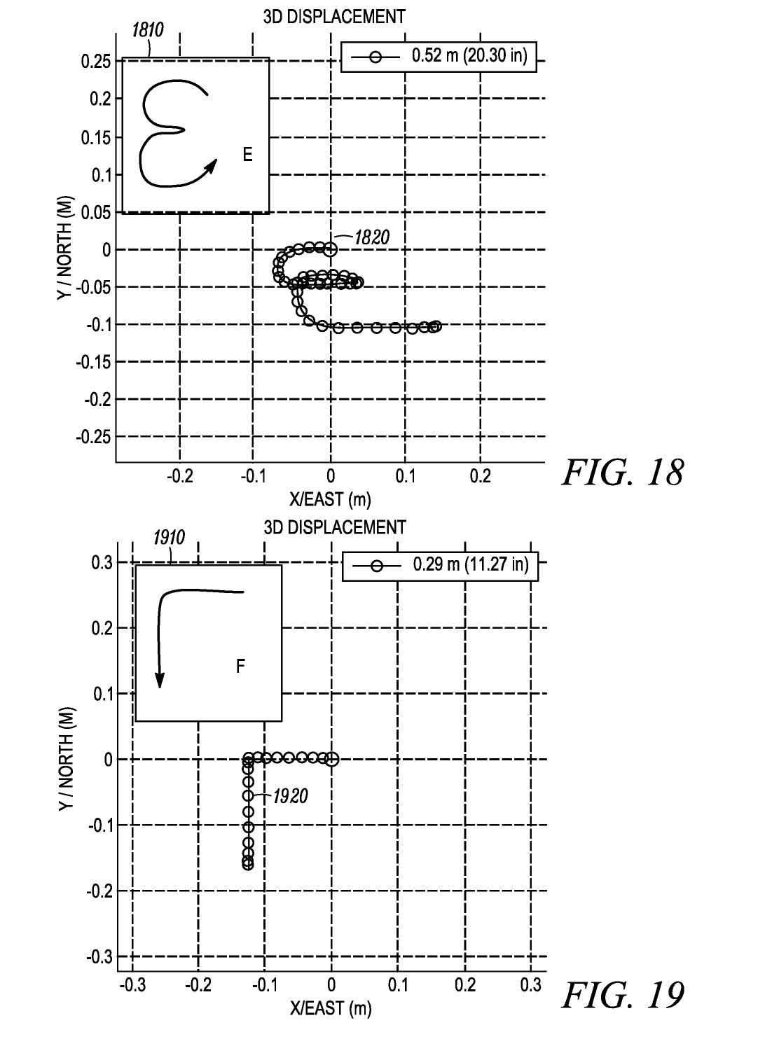

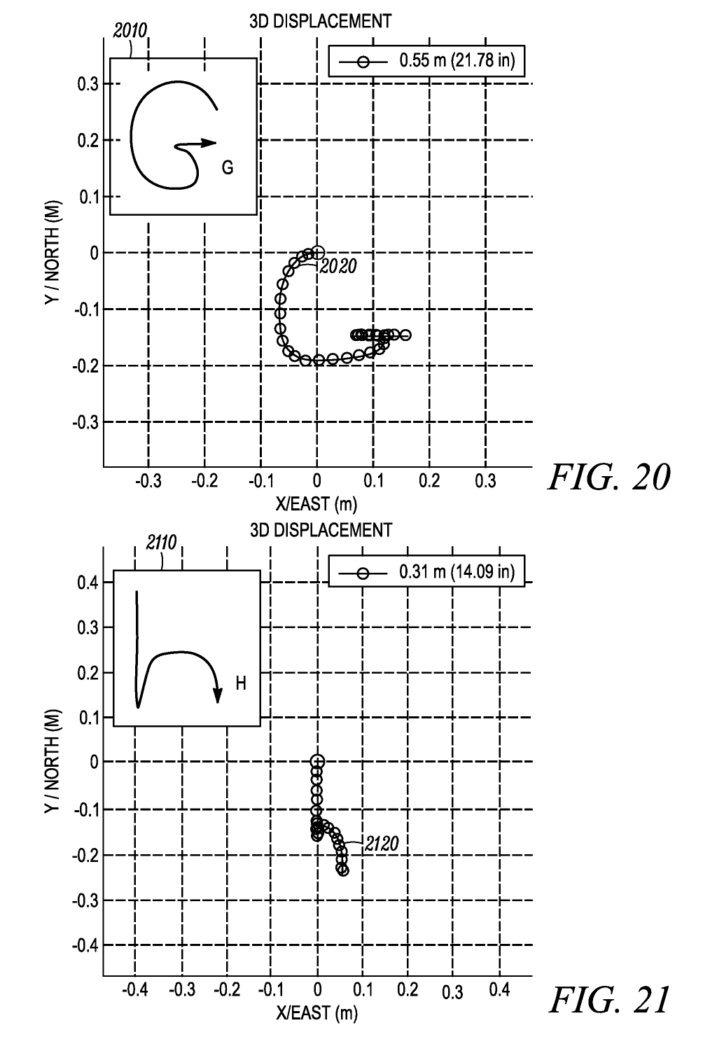

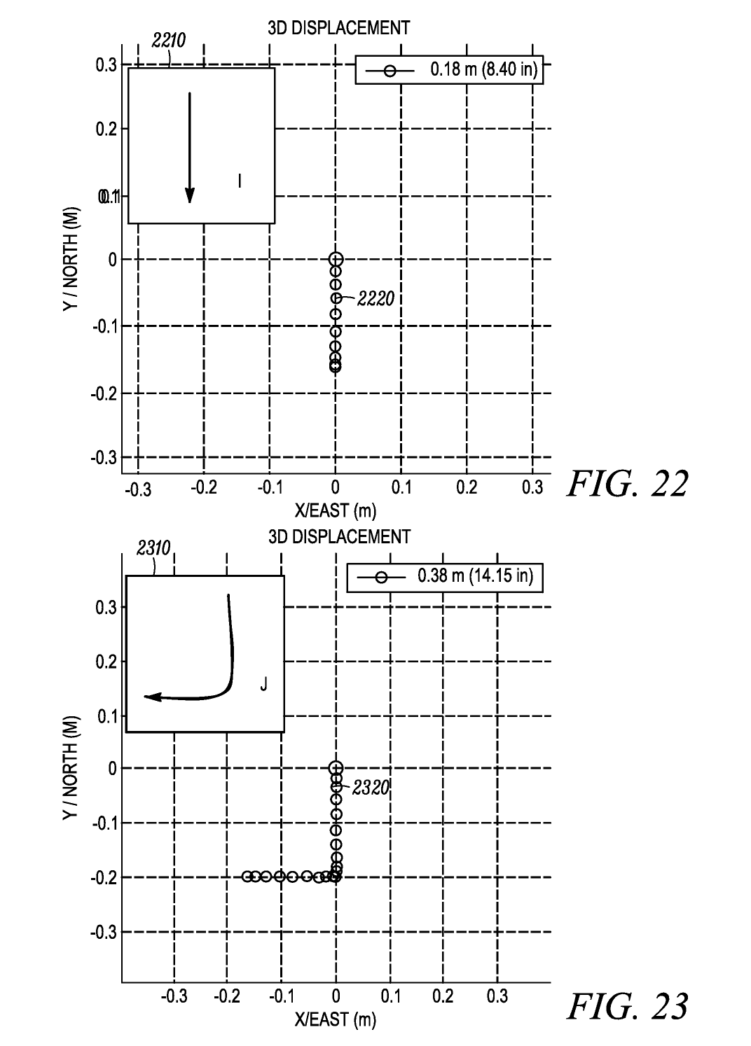

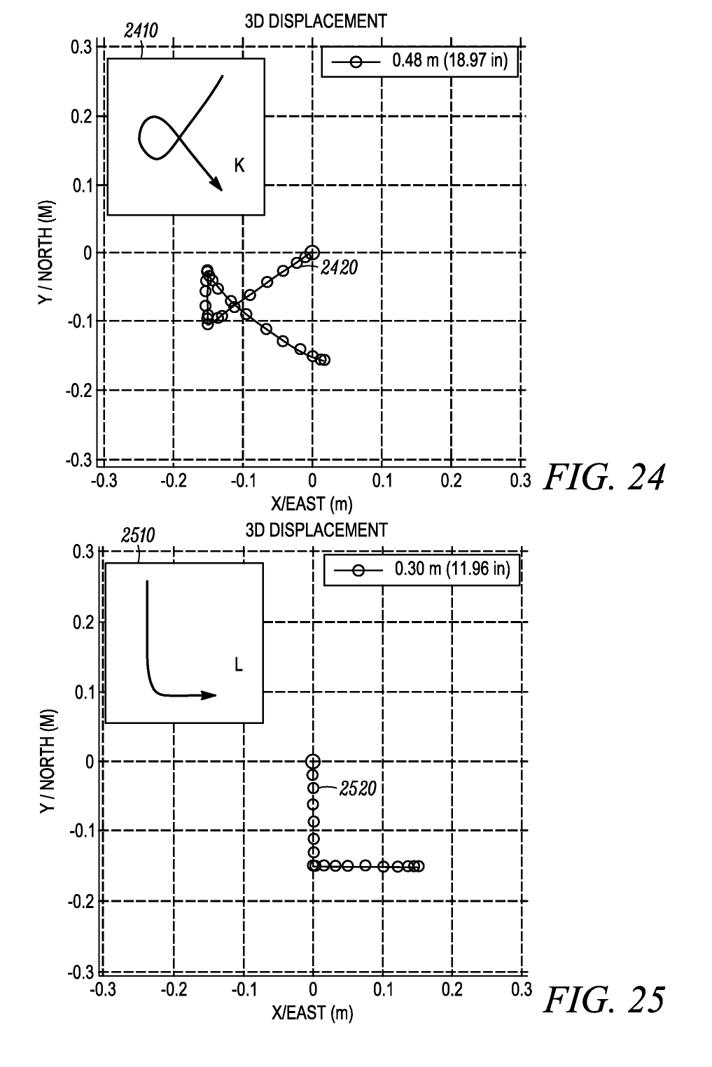

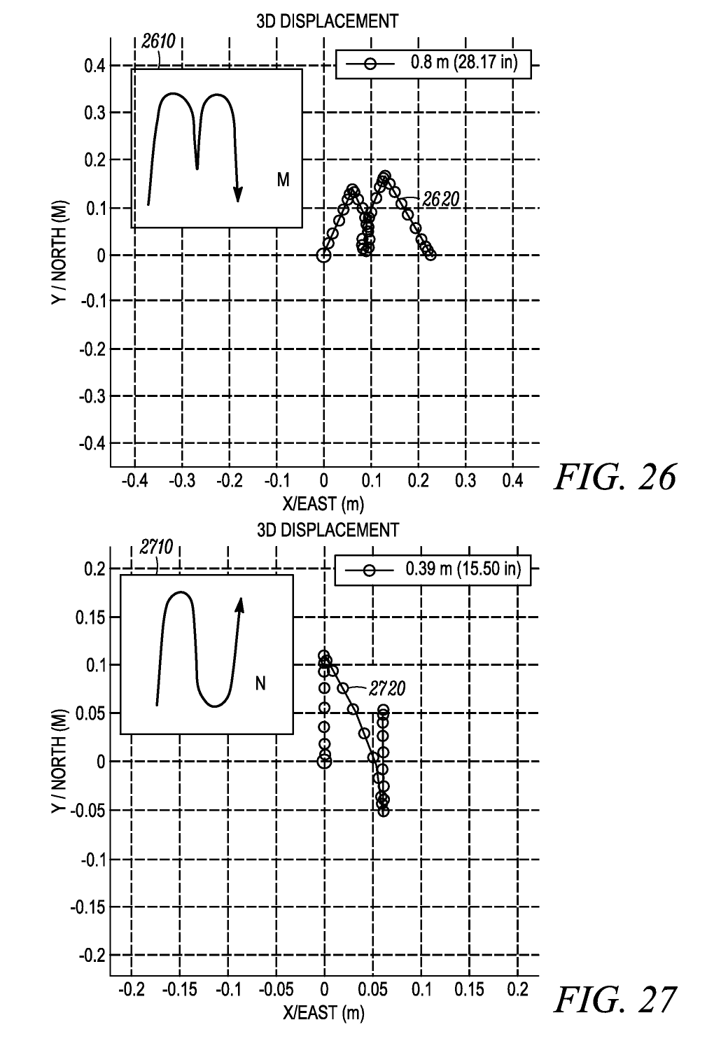

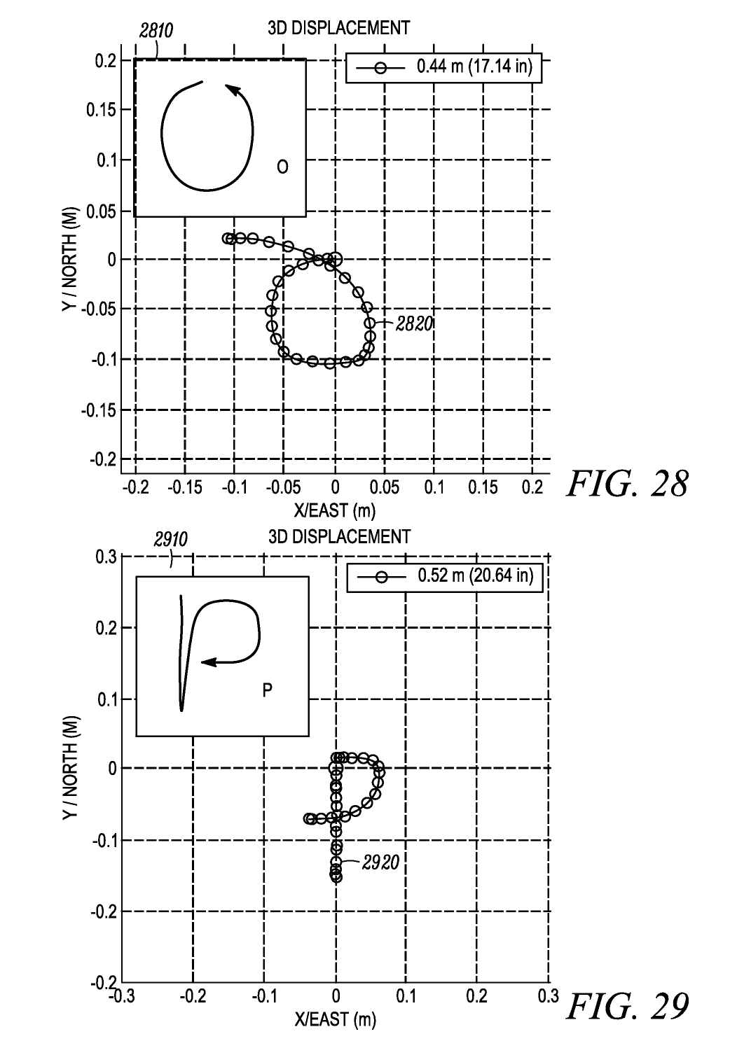

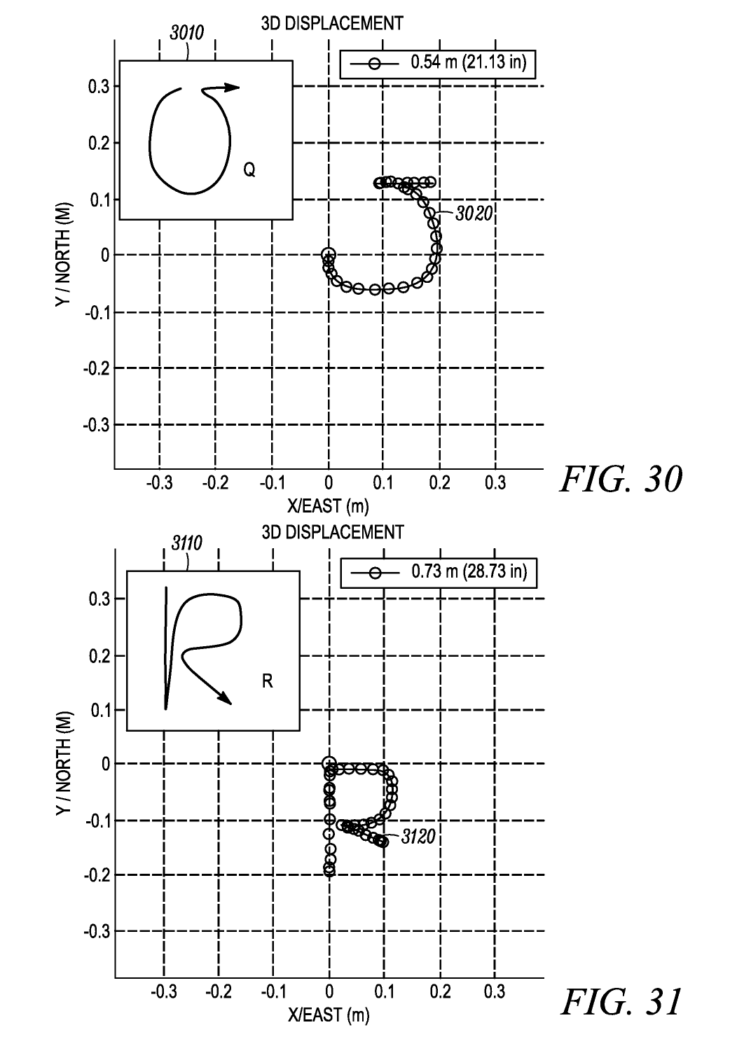

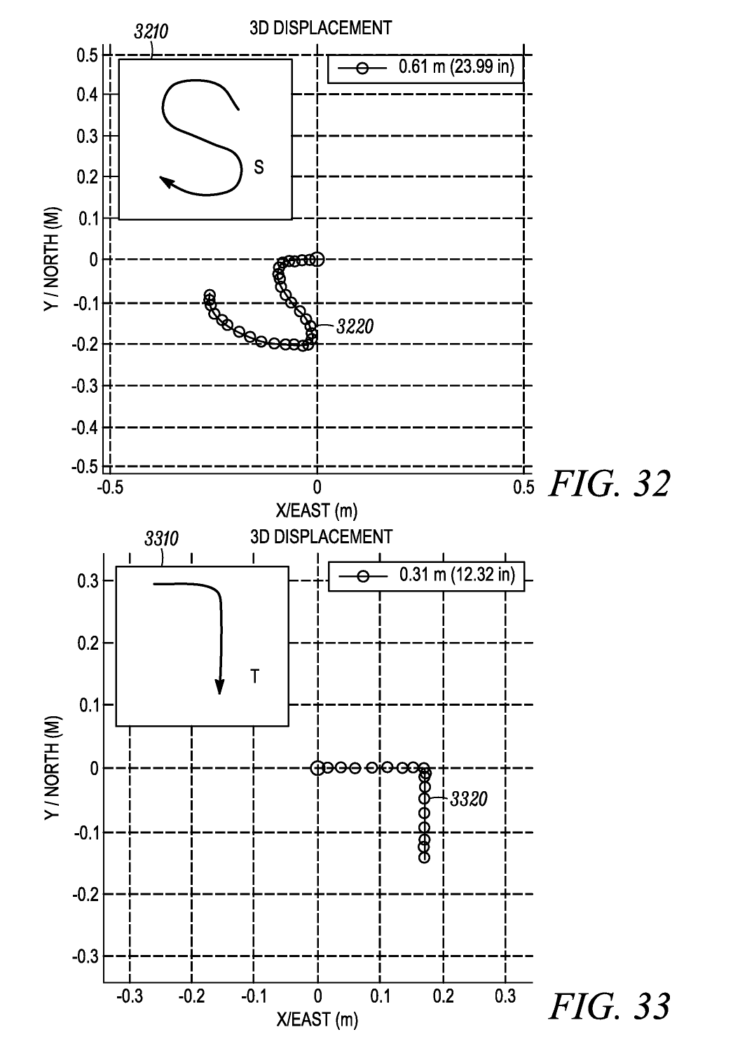

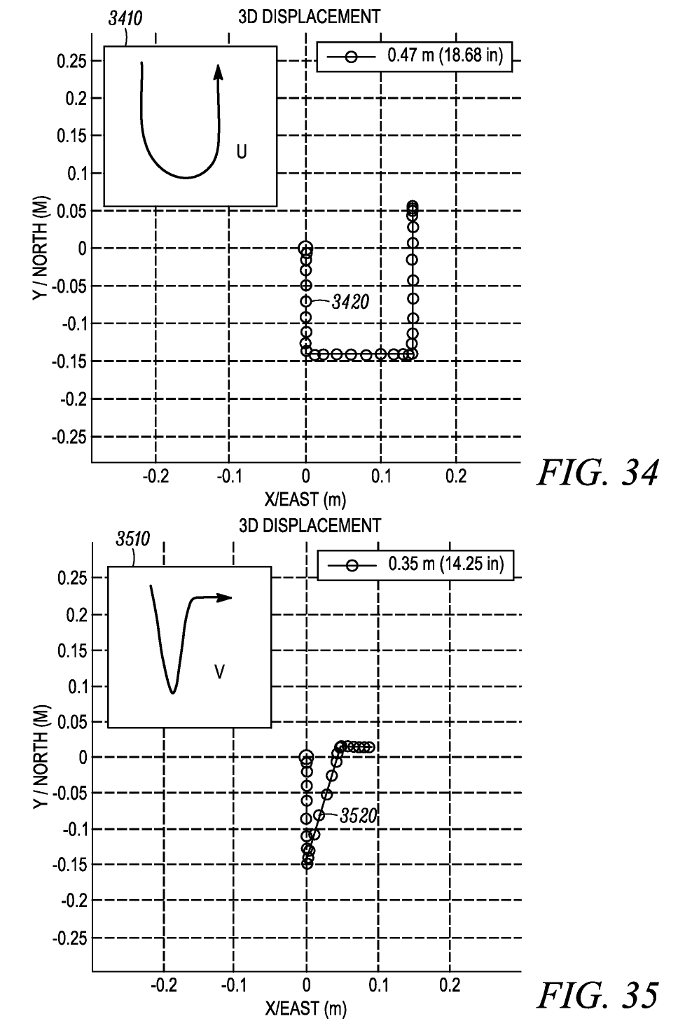

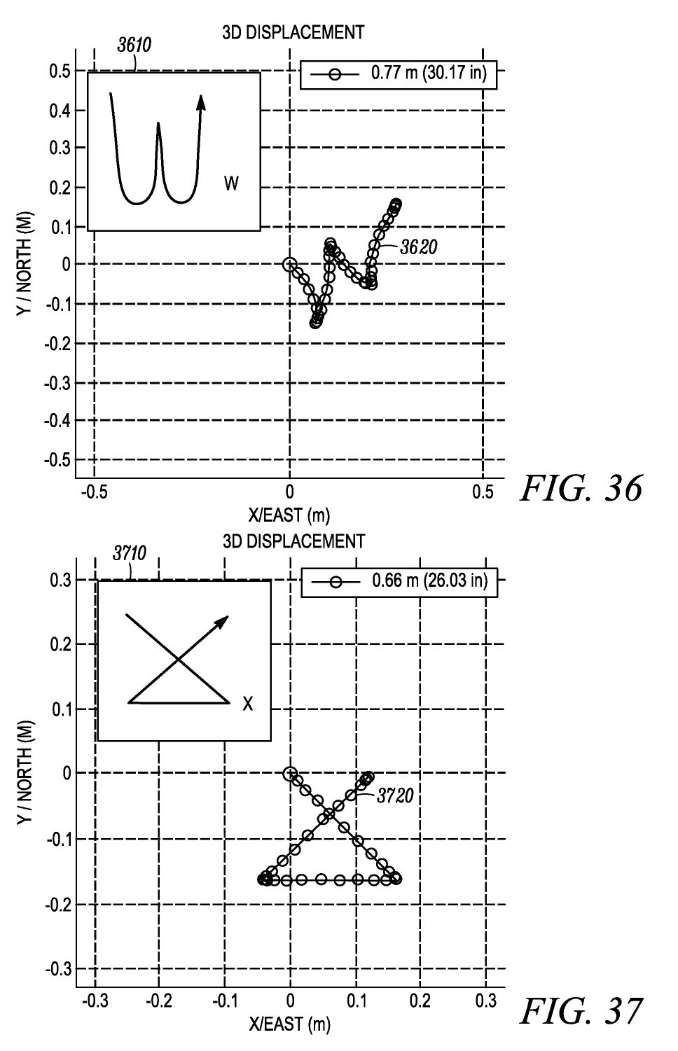

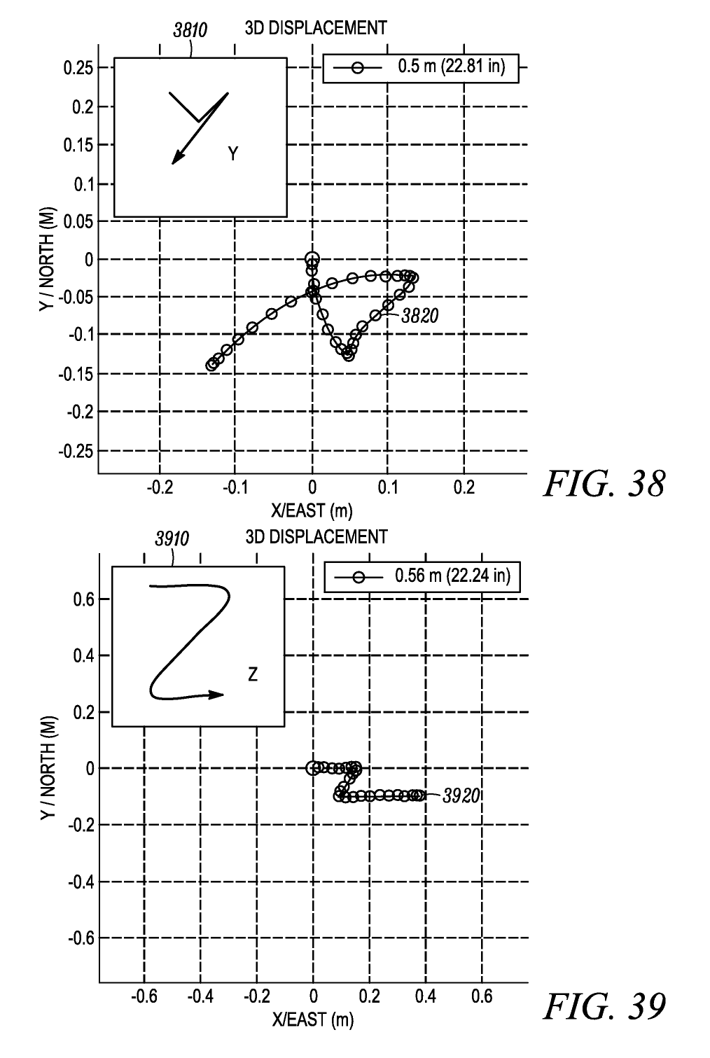

FIGS. 14-39 show a complete alphabet (A to Z) example for reconstructing displacement from acceleration data. Each letter of the alphabet is represented by a single stroke using a variant of the Graffiti™ text input system. FIG. 14 represents the letter A, FIG. 15 represents the letter B, and continuing to FIG. 39 represents the letter Z. In FIG. 14, the example gesture 1410 is traced and the reconstructed gesture 1420 is shown. Similarly, FIGS. 15 through 39 show the example gestures 1510, 1610, 1710, 1810, 1910, 2010, 2110, 2210, 2310, 2410, 2510, 2610, 2710, 2810, 2910, 3010, 3110, 3210, 3310, 3410, 3510, 3610, 3710, 3810, 3910, respectively, and their reconstructed displacements 1520, 1620, 1720, 1820, 1920, 2020, 2120, 2220, 2320, 2420, 2520, 2620, 2720, 2820, 2920, 3020, 3120, 3220, 3320, 3420, 3520, 3620, 3720, 3820, 3920, respectively, in accordance with the flow diagram of FIG. 1.

Therefore, the disclosed method adjusts received acceleration measurements to compensate for accelerometer data inaccuracies. The method can be used in gesture recognition and user input applications. A user will be able to move an accelerometer in space in different shapes, patterns, and symbols that correspond to desired actions such as text entry, gesture control, or another type of input. Using these embodiments, displacement can be calculated from the received acceleration data and inaccuracies can be minimized.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for determining displacement from acceleration data, the method comprising:
partitioning, for an axis of acceleration, filtered acceleration data into a sequence of segments with at least one positive acceleration time segment and at least one negative acceleration time segment;
force fitting, by a processor, each positive acceleration time segment and an adjacent negative acceleration time segment into a model positive and negative acceleration pair curve such that a cumulative velocity value of the model positive and negative acceleration pair curves is equal to zero; and
double-integrating the model positive and negative acceleration pair curves to obtain displacement corresponding to the acceleration data.

2. The method of claim 1, wherein the force fitting comprises:
determining a cumulative velocity value for the sequence of segments;
if the cumulative velocity value is not equal to zero, subtracting a portion of the cumulative velocity value from each positive acceleration time segment and each negative acceleration time segment to result in an updated cumulative velocity value equal to zero.

3. The method of claim 2, wherein the subtracting comprises:
subtracting an equal fraction of the cumulative velocity value from each positive acceleration time segment and each negative acceleration time segment.

4. The method of claim 1, wherein the force fitting comprises:
expanding the sequence of segments into matched pairs of positive-and-negative segments such that a cumulative velocity value of each matched pair sums to zero.

5. The method of claim 4, wherein the expanding comprises:
modifying a positive acceleration time segment into two positive acceleration time segments.

6. The method of claim 1, wherein a maximum positive amplitude of the model positive and negative acceleration pair curve is equivalent to a maximum negative amplitude of the model positive and negative acceleration pair curve.

7. The method of claim 1, wherein a time span of a positive amplitude portion of the model positive and negative acceleration pair curve is equal to a time span of a negative amplitude portion of the model positive and negative acceleration pair curve.

8. The method of claim 1, further comprising:
receiving the acceleration data; and
filtering the acceleration data to produce filtered acceleration data.

9. The method of claim 8, wherein the filtering comprises:
smoothing.

10. The method of claim 8, wherein the filtering comprises:
noise suppression.

11. The method of claim 8, wherein the filtering comprises:
bias elimination.

12. An apparatus for determining displacement from acceleration data, the apparatus comprising:
a partitioner configured to partition, for an axis of acceleration, filtered acceleration data into a sequence of segments with at least one positive acceleration time segment and at least one negative acceleration time segment;
a processor configured to force fit each positive acceleration time segment and an adjacent negative acceleration time segment into a model positive and negative acceleration time pair curve such that a cumulative velocity value of the model positive and negative acceleration time pair curves is equal to the zero;
a double integrator configured to double integrate the model positive and negative acceleration time pair curve to obtain the displacement corresponding to the acceleration data.

13. The apparatus of claim 12, wherein the processor force fits each positive acceleration time segment and an adjacent negative acceleration time segment into a model positive and negative acceleration time pair curve by:
determining a cumulative velocity value for the sequence of segments;
if the cumulative velocity value is not equal to zero, subtracting a portion of the cumulative velocity value from each positive acceleration time segment and each negative acceleration time segment to result in an updated cumulative velocity value equal to zero.

14. The apparatus of claim 13, wherein the subtracting comprises:
subtracting an equal fraction of the cumulative velocity value from each positive acceleration time segment and each negative acceleration time segment.

15. The apparatus of claim 12, wherein the processor force fits each positive acceleration time segment and an adjacent negative acceleration time segment into a model positive and negative acceleration time pair curve by:
expanding the sequence of segments into matched pairs of positive-and-negative segments such that a cumulative velocity value of each matched pair sums to zero.

16. The apparatus of claim 15, wherein the processor expands the sequence of segments into matched pairs of positive-and-negative segments by:
modifying a positive acceleration time segment into two positive acceleration time segments.

17. The apparatus of claim 15, wherein the processor expands the sequence of segments into matched pairs of positive-and-negative segments by:
modifying a negative acceleration time segment into two negative acceleration time segments.

18. The apparatus of claim 12, wherein a maximum positive amplitude of the model positive and negative acceleration time pair curve is equivalent to a maximum negative amplitude of the positive and negative acceleration time pair curve.

19. The apparatus of claim 12, wherein a time span of a positive amplitude portion of the model positive and negative acceleration time pair curve is equal to a time span of a negative amplitude portion of the model positive and negative acceleration time pair curve.

20. The apparatus of claim 12, further comprising:
an accelerometer for providing the acceleration data.

21. The apparatus of claim 12, further comprising:
a filter for filtering the acceleration data to produce filtered acceleration data.
